(19) United States
(12) Patent Application Publication
(10) Pub. No.: US 2022/0101243 A1
(43) Pub. Date: Mar. 31, 2022

(54) SYSTEMS AND METHODS FOR ACCOUNT MANAGEMENT

(71) Applicant: E. & J. Gallo Winery, Modesto, CA (US)

(72) Inventors: Ted Seburn, Livermore, CA (US); Chad Rich, Pleasanton, CA (US)

(21) Appl. No.: 17/486,078

(22) Filed: Sep. 27, 2021

Related U.S. Application Data
(60) Provisional application No. 63/085,056, filed on Sep. 29, 2020.

(51) Int. Cl. G06Q 10/08; G06Q 10/06

(52) U.S. Cl. CPC G06Q 10/08; G06Q 10/063116; G06Q 10/063114

(57) ABSTRACT

The disclosure relates to a method of implementing account management and product distribution techniques. An example method includes providing a supply management platform in communication with a supplier computer system, a distributor computer system, and a retail computer system; receiving a sales objective from the supplier computer system or the distributor computer system, the sales objective being derived using a predictive model in the supplier computer system, the sales objective being approved using the distributor computer system; providing the sales objective to the retail computer system; receiving a status update related to the sales objective; forwarding the status update to at least one of the supplier computer system or the distributor computer system; and based on the status update, facilitating an adjustment of a supply of at least one of the products for the at least one of the retail accounts.

### CROSS-REFERENCE TO RELATED APPLICATIONS

This application claims the benefit of and priority to U.S. Provisional Application No. 63/085,056, titled “Systems and Methods for Account Management” and filed under Attorney Docket No. EJG-090PR on Sep. 29, 2020, the entire contents of which are incorporated by reference herein.

### FIELD OF TECHNOLOGY

The following disclosure relates to systems and methods for account management, and in certain examples, to a computer-implemented platform for facilitating product distribution in a three-tier distribution system.

### BACKGROUND

In general, a three-tier distribution system can involve or include the following three tiers: (i) suppliers (alternatively referred to herein as “producers”), (ii) distributors (alternatively referred to herein as “wholesalers,” “partners,” or “wholesale distributors”), and (iii) retailers. In the context of alcoholic beverages, for example, suppliers can be entities that make or import alcoholic beverage products, such as breweries, wine makers, distillers, and/or importers. The suppliers can sell their products to distributors who can have an inventory of products from multiple producers or suppliers. The distributors can utilize a sales team or sales representatives to sell the products to retailers (e.g., bars, restaurants, and stores), which can in turn sell the products to consumers. In certain examples, an “account” can refer to one or more retail outlets (e.g., a store, a bar, and/or a restaurant) or other location that sells a product to a consumer.

In general, suppliers understand brand and product strategy and can struggle to activate that in the marketplace effectively without a strong connection to the sales call or sales representative at the retail account. From the supplier's perspective, however, a key challenge of the three-tier distribution system is engaging the right account with the right product at the right time. Therefore, there is a need for improved systems and methods for account management and product distribution.

The foregoing discussion, including the description of motivations for some embodiments of the invention, is intended to assist the reader in understanding the present disclosure, is not admitted to be prior art, and does not in any way limit the scope of any of the claims.

### SUMMARY

In one aspect, the subject matter of this disclosure relates to a computer-implemented method of implementing account management and product distribution techniques. The method includes: providing a supply management platform in communication with a supplier computer system, a distributor computer system, and a retail computer system, wherein the supplier computer system is managed by a supplier of a plurality of products, the distributor computer system is managed by a distributor of the plurality of products, and the retail computer system is associated with a plurality of retail accounts; receiving, at the supply management platform, at least one sales objective from at least one of the supplier computer system or the distributor computer system, wherein the at least one sales objective relates to at least one of the retail accounts, the at least one sales objective was derived using at least one predictive model in the supplier computer system, and the at least one sales objective was approved using the distributor computer system; providing, by the supply management platform, the at least one sales objective to the retail computer system, wherein the retail computer system includes a client device of a sales representative for the at least one of the retail accounts; receiving, at the supply management platform and from the client device, a status update related to the at least one sales objective; forwarding, by the supply management platform, the status update to at least one of the supplier computer system or the distributor computer system; and based on the status update, facilitating, by the supply management platform, an adjustment of a supply of at least one of the products for the at least one of the retail accounts.

In general, the systems and methods described herein can improve account management and product distribution by providing an end-to-end secure and reliable data pipeline that connects the supplier, the distributor, sales representative, and/or retail account. The platform can enable precision targeting of products for sale in the marketplace in the right account, at the right time. For example, unlike previous customer relationship management (CRM) or sales management tools, the systems and methods described herein can focus on the account as a key consideration for management and time series information. Such focus on the account can enable a supplier to keep a clear perspective on activity in the account despite any changes that may occur in the distribution pipeline, such as, for example, changes in sales representatives, products, and/or distributors over time.

In some instances, the systems and methods described herein can connect supplier and distributor layers or computer systems, while allowing autonomy individually between the supplier and distributor and, at the same time, allowing the supplier and distributor to align and collaborate on shared goals and opportunities. The systems and methods described herein can focus on the account or store level for opportunity identification and activity planning. This allows goals and objectives to be built from a bottoms up (e.g., from a store or account up to the supplier), with the systems and methods being prescriptive at an account level. For example, the systems and methods can facilitate the creation of goals for a specific account and can provide data to keep the supplier and/or distributor apprised of conditions in the account. This allows the supplier and/or distributor to revise the goals, as needed, based on recent data and/or changes in conditions in the account. By contrast, previous CRM tools use a tops down approach in which stores or accounts inherit an allocation of macro goals from a supplier and/or distributor.

In some instances, for example, the systems and methods described herein utilize a platform that feeds account, sales, product, and other related information into one or more algorithms, which can be used by suppliers to determine goals, objectives, or incentives (e.g., related to products or accounts). The platform can provide a pipeline for suppliers to directly impact sales at retail locations through the three-tier distribution system.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic diagram of a system for managing accounts and distributing products, in accordance with certain embodiments;

FIG. 2 is schematic diagram of an example system for implementing account management and product distribution techniques, in accordance with certain embodiments;

FIG. 3 is a flowchart of an example method of implementing account management and product distribution techniques, in accordance with certain embodiments; and

FIG. 4 is a block diagram of an example computer system, in accordance with certain embodiments.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

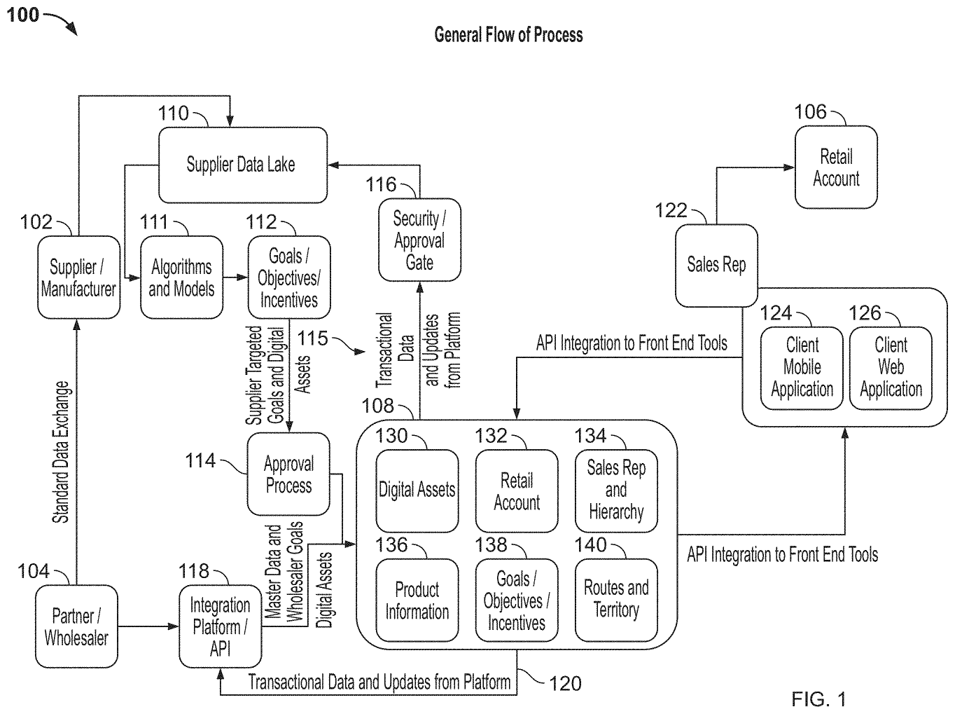

FIG. 1 is a schematic diagram of a system 100 for managing accounts and distributing products according to certain embodiments of this disclosure. The system includes a supplier 102, a distributor 104, a retail account 106, and a supply management platform 108. In general, the supplier 102, the distributor 104, and the retail account 106 can each include or be associated with its own computer system (e.g., a supplier computer system, a distributor computer system, and a retail computer system, respectively). The computer systems can be connected to the supply management platform by one or more networks (e.g., the Internet).

In various examples, the supplier 102 can be, but is not limited to, a manufacturer of one or more products. The supplier 102 can have or maintain a data lake 110 that includes or stores information related to the supplier 102, such as, for example, unique distributor identification data, products sold and quantities sold by unique distributor, products and quantities purchased by each distributor, unique accounts associated with each distributor, products purchased and sold by each account associated with each distributor, and/or account geographical location (e.g., longitude and latitude for each account), which can be used in algorithms for generating specific goals for an account (e.g., based on products sold at competitor stores within a geographic area of the account). Information from the data lake 110 can be provided to one or more algorithms or models 111 that can be used to derive one or more goals, objectives, and/or incentives 112 for the supplier 102.

In some examples, the algorithms or models 111 can be used to predict product sales and/or the influence of various factors (e.g., price) on sales. The algorithms or models 111 can be or include, for example, a nearest neighbors model (or similar classifier, regression model, or clustering algorithm) in which information about an account (e.g., sales history, demographics, socio-economic information, geographic information, and/or similar information) is used by the model to identify opportunities for additional sales based upon results from “similar” accounts in other geographical locations (e.g., other cities, states, countries, or regions). For example, the model may determine that a store in a town on the West coast looks similar to a store in a town in the Midwest (e.g., based on a similar or corresponding sales history, demographics, etc.), and that a particular product is selling well in the Midwest store but is not being sold in the West coast store. Based on the determination, the model can create or be used to create a goal 112 for the West coast store to begin selling the product.

In one embodiment, such goals, objectives, and/or incentives 112 can be targets that are provided to a sales representative in an account. In one example, a goal 112 can be to sell 20 cases of a beverage product (e.g., BAREFOOT) to a grocery store. Alternatively or additionally, in a particular grouping of accounts, a “by the glass” program may be incented on so that if N number of accounts purchase a by the glass program for a particular product, the sales representative may be awarded additional compensation in some form for that outcome. Another example of a goal may be to drive distribution for a new product A into N number of new accounts in a market. The goal can be tied to an incentive for performance and completion of the goal.

Still referring to FIG. 1, the goals 112 can be submitted to an approval process 114 in which the distributor 104 can accept, deny, or modify the goals 112. The approval process 114 can be controlled or performed by the distributor 104. Once approved, the goals 112 can be provided to the supply management platform 108, which can distribute the goals 112 to one or more sales representatives, as described herein. The supply management platform 108 can output transactional data and/or updates 115, which can be or include, for example, information related to quantities (e.g., cases or bottles) of products sold to a specific account, photographs of product displays visible within an account, surveys of competitor products (e.g., products offered by a different supplier) available for purchase in an account, and/or related information. The transactional data and/or updates 115 can be added to the data lake 110, after passing through a security or approval gate 116, which can be used to ensure that the supplier 102 does not receive any confidential or private information.

In one embodiment, the distributor 104 can exchange data with the supplier 102 and can access the supply management platform 108 through an integration platform or application programing interface (API) 118. The distributor 104 can provide the supply management platform 108 with information such as master data, goals, or digital assets. This information can be or include, for example, presentations with product detail to leverage as a selling aid, product visuals to demonstrate the visual appearance of a product, visual aids to demonstrate appearance of sales materials, such as a Display Case or sales flyer, master data such as account contact details, social media resources, shelf display diagrams and specific goals, such as “Sell X number of cases of Product A and Product B at Y number of retail channels (e.g., grocery, liquor, or convenience stores) during a given time period,” and/or related information. The distributor 104 can receive from the supply management platform 108 transactional data and/or updates 120. The transactional data and/or updates 120 can be or include, for example, information related to goals completed by a sales representative, goals not completed by a sales representative, photographic evidence of a goal completed at a specific retail outlet, a daily plan of activities to be performed by a sales representative by account, and/or similar information.

In one embodiment, on a retail side, the retail account 106 can be managed by one or more sales representatives 122 who can sell products for the retail account 106 (e.g., including one or more retail stores). The sales representatives 122 can access the supply management platform 108 using, for example, a client mobile application 124 and/or a client web application 126. The client mobile application 124 and the client web application 126 can be connected to or integrated with the supply management platform 108 using, for example, an API integration to front end tools. This can allow the client mobile application 124 and the client web application 126 to receive information from the supply management platform 108, such as, for example, information related to accounts, products, users, user/manager hierarchies, users assigned to a route, products assigned to a route, program goals to be completed by a sales representative, and/or similar information. Additionally or alternatively, the client mobile application 124 and the client web application 126 can provide information to the supply management platform 108, such as, for example, information related to account contact updates, photographs of goals that have been completed by a sales representative, number of bottles or cases of products sold in conjunction with completing a goal for an account, and/or similar information.

In one embodiment, in the depicted example, the supply management platform 108 can include one or more modules (e.g., including software and/or storage components) for handling or processing information related to digital assets, retail accounts, sales representatives and sales hierarchy (e.g., sales management), products, goals/objectives/incentives (e.g., sales objectives), and/or routes and territory. For example, a digital asset management (DAM) technology module 130 can be used to manage or provide flyers, marketing materials, or other digital assets. The digital asset management (DAM) technology module 130 can receive digital assets from one or more system components (e.g., from the supplier 102, the distributor 104, and/or the retail account 106), store the digital assets, and send the digital assets to one or more system components. A retail account module 132 can be used to manage or provide information related to one or more retail accounts (e.g., the retail account 106). For example, the retail account module 132 can receive, store, and provide information related to the retail accounts, such as sales data, inventory data, geographic location, customer demographics, etc. A sales representative and hierarchy module 134 can be used to manage or process (e.g., receive, store, or provide) information related to sales representatives and sales management personnel. Such information can include, for example, a mapping of sales personnel to respective retail accounts, sales data, incentives, etc. A product information module 136 can be used to manage or process (e.g., receive, store, or provide) information related one or more products. Such information can include, for example, product data (e.g., composition, size, volume, weight), sales data, sales trends, etc. A goals/objectives/incentives module 138 (alternatively referred to as the goals module 138) can be used to manage or process (e.g., receive, store, or provide) information related to one or more goals 112 of the supplier 102 (e.g., as approved or modified by the distributor 104). Such goals can be pushed by the goals/objectives/incentives module 138 to sales personnel handling retail accounts. A routes and territory module 140 can be used to manage or process (e.g., receive, store, or provide) information related to routes for sending products to accounts in one or more territories.

In one example related to a winery supplier, a supplier goal system (e.g., including the algorithms and models 111) can be loaded with goals or objectives 112 that contain appropriate filtering criteria to identify relevant accounts. The objectives 112 can be sent to the supply management platform 108 (e.g., through a RESTful API call) and added to a management console for approval in the approval process 114. Personnel at the distributor 104 can use the approval process 114 to approve or modify the objectives, as desired. A state change (e.g., approved, rejected, or modified) and relevant details can be sent back to the supplier (e.g., via a RESTful API call or on a KAFKA stream). New objectives can then be allocated, assigned, or otherwise “blown down” to appropriate accounts for the distributor 104 in the supply management platform 108 and can be available to the sales representative 122 (e.g., using the client mobile application 124 and/or the client web application 126). When the sales representative 122 uses a client device (e.g., a mobile device, a personal computer, a tablet computer, or other data processing device) to open the client mobile application 124 and/or the client web application 126, the client device can synchronize with a server and can store a local copy of all objectives 112 and other materials that are needed for the sales representative 122 to complete his or her work according to the objectives 112 for the retail account 106. The sales representative 122 can complete the work while at the retail account 106 and can provide a status update for the objectives using the client mobile application 124 and/or the client web application 126. Once a connection is available, the status update or other information related to the objectives 112 (e.g., sales and/or inventory data) can be sent from the client device of the sales representative 122 to the supply management platform 108. Once received and/or stored in a database, the updated objectives and associated metadata can be published (e.g., via a KAFKA stream) to the supplier 102 for consumption (e.g., after passing through the approval gate 116). The data can be consumed or used by the supplier 102 and stored in the data lake 110. The algorithms and models 111 can use the data in the data lake 110 to generate new or updated objectives 112, and the process can be repeated.

In various examples, account information can be or include data related to the retail account 106 (e.g., basic/master data). Account information can come from the distributor 104 and/or third parties to the supplier 102. Such accounts can be captured or derived from agreements among the supplier 102, the distributor 104, and/or the retail account 106. In some instances, TDLinx can be used to provide account information. Sales can be or include actual sales to the retail account 106 (e.g., for a product), and sales data for the retail account 106 can be collected by the distributor 104 and provided to the supplier 102. In some instances, there may be agreements between the supplier 102 and the distributor 104 that can provide invoice level information for one or more accounts 106. A product can be an actual product and/or can be associated with basic data or master data related to the product. Such data can come directly from the supplier 102, which can own the data and all information that enriches or modifies the data. Demographic information can be sourced from various public sources, as needed, to enable the supplier 102 or distributor 104 to understand basic demographic or socio-economic information related to accounts 106 in question. Once all the information related to accounts, sales, products, and demographics is collected or obtained, an analysis on sales trends and performance can be run (e.g., using the algorithms and models 111).

In certain examples, an objective 112 (e.g., from the supplier 102) can be pushed out to the sales representative 122 who can try to sell a product to a store or retail account 106 having a certain set of demographics. This can be achieved by, for example: (i) running a model (e.g., the models 111) on data in the data lake 110 to understand potential opportunity accounts and/or markets; (ii) generating a series of recommended objectives 112 using a supplier goaling system (e.g., the algorithms and models 111) for validation and “publication” to the distributor 104; (iii) publishing a target objective 112 to the distributor for their approval and “publication” into approved goals/incentives/objectives 112 that are being assigned to the retail account 106 and the sales representative 122; and (iv) when the sales representative 122 prepares for a sales pitch at a retail account 106, the objectives 112 can be reviewed and activated (e.g., using the goals/objectives/incentives module 138).

In various implementations, data can be exchanged in the system 100 through a series of API calls between the supplier 102, the supply management platform 108, and/or other system components. The API calls can utilize, for example, RESTful services that pass JSON objects between the supplier 102 and the supply management platform 108. An example JSON object for a “GetProduct” call can be as follows.

{

″Status″: 1, ″Message″: ″Success″, ″Result″: { ″BRAND_ID″:
″475″,″BRAND_CODE″: ″1896159″,″BRAND_NAME″: ″MRQ DE LA
MUSA″,″FLAVOR_CODE″: null,″FLAVOR_NAME″: null,″SIZE_CODE″:
″001″,″SIZE_NAME″: ″750ML″,″LOB_CODE″: null,″LOB_NAME″:
null,″UPC_PROD_DESC″: ″750ML MRQ DE LA MUSA GARNACHA″, ″UPC″:
″84279987972″,″LA_FLV_CD″: null,″LA_FLV_DESC″: null,″CATEGORY″:
″TABLE″,″VARIETAL″: null,″BRAND_APPELL″: ″MRQ DE LA MUSANA″,
″RPT_SEQ_N″: ″99″, ″APPELLATION_ID″: null,″APPELL″:
null,″APPELL_DESC″: null,″TIER_CD″: null,″TIER_DESC″: null,″Standard″:
0,″SUPPLIER″: null,″DistributorId″: null, ″DistributorName″: null,″ClientCode″:
null,″IsActive″: true,″ProductId″: “string”,″CreatedBy″: null,″CreatedDate″: ″0001-
01-01T00:00:00″, ″UpdatedBy″: null, ″UpdatedDate″: ″0001-01-01T00:00:00″ }

}

In certain examples, the algorithms or models 111 can be or include a variety of models for determining one or more goals, objectives, or incentives 112. The models 111 can be used to identify opportunities at a store level (e.g., a specific store) by using a combination of available data, goals (e.g., from a supplier), and/or incentive programs. These opportunities can then be used to define specific selling activities or objectives which the sales representative can implement in the store. The models 111 can include, for example, account management models that can remove duplicates (e.g., duplicate accounts) and/or ensure consistency across all accounts. Inputs to the models 111 can be, include, or relate to, for example, historical depletion data (e.g., related to inventory or sales), demographic data, syndicated data, and/or consumer data. Additionally or alternatively, the models 111 can include depletion models that can determine key performance indicators (KPIs), such as accounts purchasing and points of distribution. Such depletion models can provide KPIs for goals and incentives that can be pushed to the sales representatives 122. Additionally or alternatively, the models 111 can include a nearest neighbors model for identifying combinations of accounts and products that are under-represented (e.g., to create new objectives and goals).

In various implementations, the models 111 can include or utilize a machine learning model or other predictive tool. In general, any suitable machine learning or predictive modeling technique can be used, such as, for example: a gradient boosted random forest, a regression, a neural network, a decision tree, a support vector machine, a Bayesian network, or other type of technique. The models 111 can be trained using a set of training data. The training data can be or include, for example, historical data related to accounts, including sales data, inventory data, demographics data, geographical location, and the like. Such data can include information related to the model input parameters and one or more target features that the model is trying to predict (e.g., an objective or goal for an account). In general, the models 111 can be trained to recognize how to optimize, maximize, or minimize one or more target features associated with an account (e.g., sales or product inventory). Once trained, the models 111 can receive the input parameters as input and provide one or more goals or objectives as output.

In one embodiment, the approval process 114 can be used to pass goals, objectives, or incentives 112 from the supplier 102, through the distributor 104, and to one or more sales representatives 122 managing accounts 106. Such goals 112 may not be immediately activated by the distributor 104. In one implementation, a distributor 104 using the supply management platform 108 can open a management console (e.g., in the approval process 114) to see “suggested” goals 112 from the supplier 102. The distributor 104 can use the management console to accept, deny, or modify the goals as the distributor 104 deems appropriate. Data from the distributor's actions can be sent back to the supplier 102 for tracking purposes. Approved or modified items can then be “published” to the supply management platform 108 for execution by the sales representatives 122. In various examples, data exchange between the supplier 102 and the supply management platform 108 can be handled with APIs passing appropriate JSON objects between systems. API integration can be or utilize RESTful services, for example, that use a JSON payload to transfer data between the solutions. For higher volume transfer of data back from the supply management platform 108 to the supplier 102, a streaming service (e.g., KAFKA) can be leveraged that streams JSON objects for consumption in the data lake 110.

In certain implementations, the systems and methods described herein can achieve a direct connection or direct data communication link between the supplier 102 and the distributor 104, for example, involving the goals 112 and approval process 114. This can allow the supplier 102 to activate or manage sales representatives in a more prescriptive fashion (e.g., to meet desired goals) and/or to direct activities of sales representatives 122 in accounts 106. Advantageously, by connecting the supplier 102, the distributor 104, the sales representatives 122, and/or the accounts 106 in this manner, the supply management platform 108 is able to streamline communications and data exchanges among these entities. Additionally or alternatively, the supply management platform 108 can enable each of the entities to more easily determine, monitor, and/or control sales objectives, product supply and distribution, and sales activities. The supply management platform 108 can reduce network congestion by providing a central data repository and data exchange that is accessible by each entity. This facilitates data exchanges among the entities and provides a window for each entity to monitor activities and information related to the other entities. This can enable each entity to kept apprised of conditions related to the goals or objectives for the entities. Further, by facilitating direct data exchanges among the supplier 102, the distributor 104, and the account 106, more costly and time consuming communications (e.g., involving email) can be avoided, thereby reducing computer processing requirements and improving bandwidth.

Additionally or alternatively, a feedback loop of completed objectives (e.g., from sales representatives 122 to the supplier 102, via the supply management platform 108) can allow the supplier 102 to have a more real-time perspective on what is working and what is not working with respect to the supplier's goals, objectives, and/or incentives 112. The feedback loop can allow the supplier's sales management teams to engage with the distributor 104 during the middle of a selling period, for example, to align on corrections, remediations, and new objectives and/or to ensure the supplier's business achieves desired outcomes. In various examples, the distributor 104 may have a segmented tenant (e.g., a single-tenant cloud architecture) that provides security and data privacy (e.g., using the security or approval gate 116) so that only information agreed to be shared back to (or required by) the supplier 102 is shared.

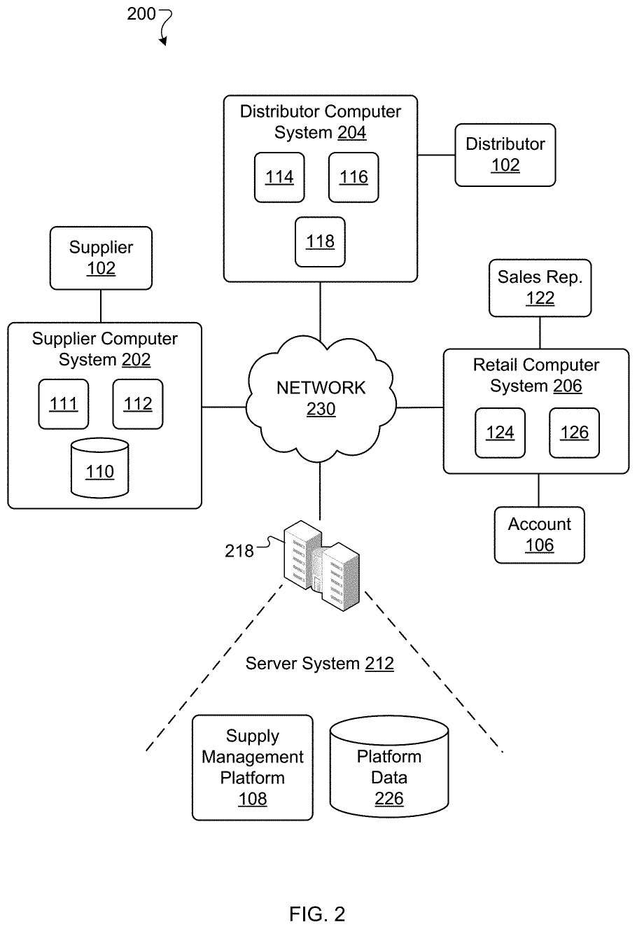

FIG. 2 illustrates an example system 200 for implementing the account management and/or product distribution techniques described herein. The system 200 includes a supplier computer system 202 (e.g., operated or managed by the supplier 102), a distributor computer system 204 (e.g., operated or managed by the distributor 104), a retail computer system 206 (e.g., operated or managed by one or more retail accounts 106), a network (e.g., the Internet), and a server system 212. In the depicted example, the network 230 connects the supplier computer system 202, the distributor computer system 204, the retail computer system 206, and the server system 212. As described above, the supplier computer system 202 can include, use, or produce the data lake 110, the one or more algorithms or models 111, and/or the one or more goals, objectives, and/or incentives 112. Likewise, the distributor computer system 204 can include, use, or produce the approval process 114, the security or approval gate 116, and/or the API 118. The retail computer system can include, use, or produce the client mobile application 124 and/or the client web application 126.

The server system 212 provides functionality for implementing the systems and methods described herein. The server system 212 includes software components and databases that can be deployed at one or more data centers 218 in one or more geographic locations, for example. The software components can include subcomponents that can execute on the same or on different individual processors or data processing apparatus. In certain instances, the server system 212 is, includes, or utilizes a content delivery network (CDN). The server system 212 software components can be or include or can implement the supply management platform 108.

As described earlier, the goals 112 can be provided to the supply management platform 108, which can distribute the goals 112 to one or more sales representatives. The supply management platform 108 can output transactional data and/or updates (e.g., to the supplier computer system 202, the distributor computer system 204, and/or the retail computer system 206), which can be or include, for example, information related to quantities (e.g., cases or bottles) of products sold to a specific account, photographs of product displays visible within an account, surveys of competitor products available for purchase in an account, and/or related information.

The databases of the server system 212 can include a platform data 226 database, which can store data used or provided by the supply management platform 108. For example, data such as transactional data and/or updates can be stored in and retrieved from the platform data 226. Information such as master data, goals, or digital assets provided by the supplier computer system 202 and/or the distributor computer system 204 to the supply management platform 108 can be stored in the platform data 226. Such information can be or include, for example, presentations with product detail to leverage as a selling aid, product visuals to demonstrate the visual appearance of a product, visual aids to demonstrate appearance of sales materials, such as a Display Case or sales flyer, master data such as account contact details, social media resources, shelf display diagrams and specific goals, such as “Sell X number of cases of Product A and Product B at Y number of retail channels (e.g., grocery, liquor, or convenience stores) during a given time period, and/or related information.”

In one embodiment, the supplier computer system 202 includes the algorithms or models 111 that can be used to derive one or more goals, objectives, and/or incentives 112 for the supplier computer system 202. The goals, objectives, and/or incentives 112 can be targets that are provided to a sales representative in an account. The data lake 110 can be maintained by the supplier computer system 202 and can include or store information related to the supplier 102, such as, for example, unique distributor identification data, products sold and quantities sold by unique distributor, products and quantities purchased by distributor, unique accounts associated with each distributor, products purchased and sold by each account associated with each distributor, and/or account geographical location (e.g., longitude and latitude for each account), which can be used in algorithms for generating specific goals for an account (e.g., based on products sold at competitor stores within the geographic area of the account). Information from the data lake 110 can be provided to one or more algorithms or models 111 that can be used to derive the one or more goals, objectives, and/or incentives 112.

The distributor computer system 204 can include the approval process 114, the security or approval gate 116, and the integration platform or application programing interface (API) 118. Personnel at the distributor 104 can use the approval process 114 to approve or modify the objectives 112. For example, the approval process 114 can be used to pass goals, objectives, or incentives 112 from the supplier 102, through the distributor 104, and to one or more sales representatives 122 managing accounts 106. The security or approval gate 116 may be used in the distributor computer system 204 so that only information agreed to be shared back to (or required by) the supplier 102 is shared. The integration platform or application programing interface (API) 118 can be used by the distributor 104 to exchange data with the supplier 102 and can be used to access the supply management platform 108.

The retail computer system 206 can include the client mobile application 124 and the client web application 126. As described earlier, the retail account 106 can be managed by a sales representative 122 who can sell products for the retail account 106. When the sales representative 122 uses a client device to open the client mobile application 124 and/or the client web application 126, the client device can synchronize with the server system 212 and can store a local copy of all objectives 112 and/or other materials that may be needed for the sales representative 122 to complete his or her work according to the objectives 112 for the retail account 106. The sales representative 122 can complete the work while at the retail account 106 and can provide a status update for the objectives using the client mobile application 124 and/or the client web application 126.

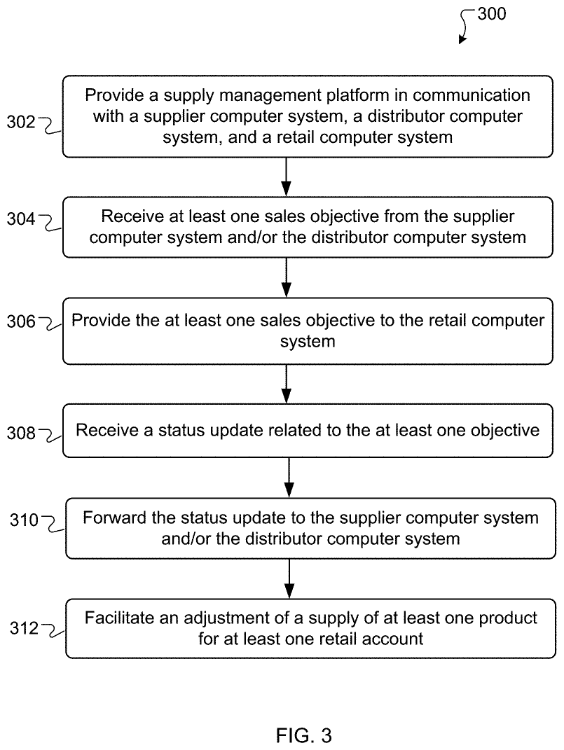

FIG. 3 is a flowchart of an example method 300 of implementing the account management and/or product distribution techniques described herein. A supply management platform is provided (step 302) and is in communication with a supplier computer system, a distributor computer system, and a retail computer system. The supplier computer system is managed by a supplier of a plurality of products, the distributor computer system is managed by a distributor of the plurality of products, and the retail computer system is associated with a plurality of retail accounts. At least one sales objective is received (step 304) from at least one of the supplier computer system or the distributor computer system. The at least one sales objective relates to at least one of the retail accounts. The at least one sales objective was derived using at least one predictive model in the supplier computer system. The at least one sales objective was approved using the distributor computer system. The at least one sales objective is provided (step 306) to the retail computer system. The retail computer system includes a client device of a sales representative for the at least one of the retail accounts. A status update related to the at least one objective is received (step 308). The status update is forwarded (step 310) to at least one of the supplier computer system or the distributor computer system. Based on the status update, an adjustment of a supply of at least one of the products is facilitated (step 312) for the at least one of the retail accounts.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

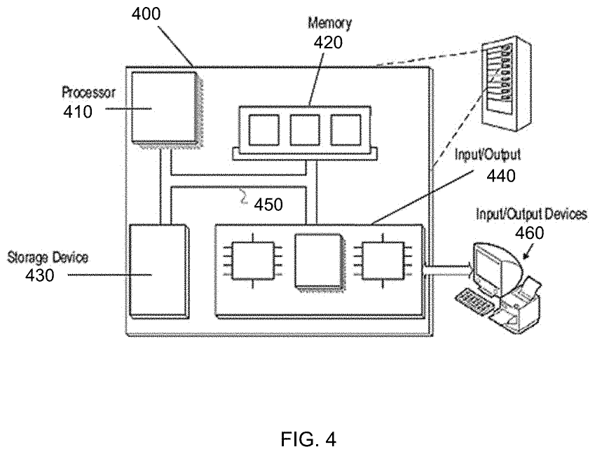

FIG. 4 is a block diagram of an example computer system 400 that may be used in implementing the technology described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-state drive, a flash drive, or some other large capacity storage device. For example, the storage device may store long-term data (e.g., database data, file system data, etc.). The input/output device 440 provides input/output operations for the system 400. In some implementations, the input/output device 440 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
providing a supply management platform in communication with a supplier computer system, a distributor computer system, and a retail computer system,
wherein the supplier computer system is managed by a supplier of a plurality of products, the distributor computer system is managed by a distributor of the plurality of products, and the retail computer system is associated with a plurality of retail accounts;
receiving, at the supply management platform, at least one sales objective from at least one of the supplier computer system or the distributor computer system,
wherein the at least one sales objective relates to at least one of the retail accounts,
wherein the at least one sales objective was derived using at least one predictive model in the supplier computer system, and
wherein the at least one sales objective was approved using the distributor computer system;
providing, by the supply management platform, the at least one sales objective to the retail computer system,
wherein the retail computer system comprises a client device of a sales representative for the at least one of the retail accounts;
receiving, at the supply management platform and from the client device, a status update related to the at least one sales objective;
forwarding, by the supply management platform, the status update to at least one of the supplier computer system or the distributor computer system; and
based on the status update, facilitating, by the supply management platform, an adjustment of a supply of at least one of the products for the at least one of the retail accounts.

2. The computer-implemented method of claim 1, wherein the supplier, the distributor, and the plurality of retail accounts comprise a three-tier distribution system, and wherein the plurality of products comprise alcoholic beverages.

3. The computer-implemented method of claim 1, wherein the at least one sales objective relates to adjusting at least one of a volume or a type of product being sold at the at least one of the retail accounts.

4. The computer-implemented method of claim 1, wherein the at least one predictive model is configured to determine similarities among the plurality of retail accounts and derive the at least one sales objective based on the similarities.

5. The computer-implemented method of claim 4, wherein the similarities relate to at least one of demographics or sales histories for the plurality of retail accounts.

6. The computer-implemented method of claim 4, wherein the at least one predictive model comprises a nearest neighbors model.

7. The computer-implemented method of claim 1, wherein providing the at least one sales objective to the retail computer system comprises providing an incentive to the sales representative for completion of the at least one sales objective.

8. The computer-implemented method of claim 1, wherein the at least one predictive model comprises at least one of an account management model configured to ensure consistency of retail accounts, a depletion model configured to determine key performance indicators, or a nearest neighbors model configured to identify combinations of retail accounts or products that are under-represented.

9. The computer-implemented method of claim 1, wherein the at least one sales objective was modified using the distributor computer system.

10. The computer-implemented method of claim 1, wherein the supply management platform includes at least one of a digital asset module, a retail account module, a sale rep and hierarchy module, a product information module, a goals module, or a routes and territory module.

11. A system comprising:
a supplier computer system, a distributor computer system, a retail computer system, and a supply management platform connected by at least one network, wherein the supplier computer system is managed by a supplier of a plurality of products, the distributor computer system is managed by a distributor of the plurality of products, and the retail computer system is associated with a plurality of retail accounts, and wherein the system comprises one or more computer processors programmed to perform operations comprising:
providing a supply management platform in communication with the supplier computer system, the distributor computer system, and the retail computer system,
receiving, at the supply management platform, at least one sales objective from at least one of the supplier computer system or the distributor computer system,
wherein the at least one sales objective relates to at least one of the retail accounts,
wherein the at least one sales objective was derived using at least one predictive model in the supplier computer system, and
wherein the at least one sales objective was approved using the distributor computer system;
providing, by the supply management platform, the at least one sales objective to the retail computer system,
wherein the retail computer system comprises a client device of a sales representative for the at least one of the retail accounts;
receiving, at the supply management platform and from the client device, a status update related to the at least one sales objective;
forwarding, by the supply management platform, the status update to at least one of the supplier computer system or the distributor computer system; and
based on the status update, facilitating, by the supply management platform, an adjustment of a supply of at least one of the products for the at least one of the retail accounts.

12. The system of claim 11, wherein the supplier, the distributor, and the plurality of retail accounts comprise a three-tier distribution system, and wherein the plurality of products comprise alcoholic beverages.

13. The system of claim 11, wherein the at least one sales objective relates to adjusting at least one of a volume or a type of product being sold at the at least one of the retail accounts.

14. The system of claim 11, wherein the at least one predictive model is configured to determine similarities among the plurality of retail accounts and derive the at least one sales objective based on the similarities.

15. The system of claim 14, wherein the similarities relate to at least one of demographics or sales histories for the plurality of retail accounts.

16. The system of claim 14, wherein the at least one predictive model comprises a nearest neighbors model.

17. The system of claim 11, wherein the at least one predictive model comprises at least one of an account management model configured to ensure consistency of retail accounts, a depletion model configured to determine key performance indicators, or a nearest neighbors model configured to identify combinations of retail accounts or products that are under-represented.

18. The system of claim 11, wherein the at least one sales objective was modified using the distributor computer system.

19. The system of claim 11, wherein the supply management platform includes at least one of a digital asset module, a retail account module, a sale rep and hierarchy module, a product information module, a goals module, or a routes and territory module.

20. An article, comprising:
a non-transitory computer-readable medium having instructions stored thereon that, when executed by one or more computer processors, cause the computer processors to perform operations comprising:
providing a supply management platform in communication with a supplier computer system, a distributor computer system, and a retail computer system,
wherein the supplier computer system is managed by a supplier of a plurality of products, the distributor computer system is managed by a distributor of the plurality of products, and the retail computer system is associated with a plurality of retail accounts;
receiving, at the supply management platform, at least one sales objective from at least one of the supplier computer system or the distributor computer system,
wherein the at least one sales objective relates to at least one of the retail accounts,
wherein the at least one sales objective was derived using at least one predictive model in the supplier computer system, and
wherein the at least one sales objective was approved using the distributor computer system;
providing, by the supply management platform, the at least one sales objective to the retail computer system,
wherein the retail computer system comprises a client device of a sales representative for the at least one of the retail accounts;
receiving, at the supply management platform and from the client device, a status update related to the at least one sales objective;
forwarding, by the supply management platform, the status update to at least one of the supplier computer system or the distributor computer system; and
based on the status update, facilitating, by the supply management platform, an adjustment of a supply of at least one of the products for the at least one of the retail accounts.
